(19) United States
(12) Patent Application Publication
(10) Pub. No.: US 2011/0005606 A1
(43) Pub. Date: Jan. 13, 2011

(54) METHOD FOR SUPPLYING A FLUID AND MICROPUMP FOR SAID PURPOSE

(76) Inventors: Frank Bartels, Hattingen (DE); Severin Dahms, Dortmund (DE); Uwe Kampmeyer, Dortmund (DE); Markus Rawert, Coesfeld (DE)

Correspondence Address: Kubotera & Associates, LLC, 200 Daingerfield Rd, Suite 202, Alexandria, VA, 22314, US

(21) Appl. No.: 12/741,241

(22) PCT Filed: Sep. 25, 2008
(86) PCT No.: PCT/EP08/08177

§ 371 Date: Sep. 10, 2010

(30) Foreign Application Priority Data
Nov. 5, 2007 (DE) 10 2007053 047.3

(51) Int. Cl. F15D 1/00

(52) U.S. Cl. 137/14; 137/565.01

(57) ABSTRACT

A device includes a number of N≧2 pump chambers having N separate chamber volumes, each of which may be altered independently of the other(s). The volume changes of the pump chambers occur periodically with substantially the same frequency (f). The device further includes N actuators for changing the respective chamber volumes and valves for establishing the pumping direction, and finally a common inlet and outlet. The pump chambers of the device are disposed in series one behind the other, and the forms of the periods of volume changes of all pump chambers are substantially identical. Moreover, an ideal phase offset PHI of approximately 180° exists between the volume change of the chamber volumes of two sequential pump chambers.

The invention relates to the field of pump-conveying engineering, and in particular to methods for the pumping of small and smallest amounts of a fluid, and here, particularly pumps which are constructed from pump chambers, membrane actuators, and valves.

### STATE OF THE ART AND DISADVANTAGES

Pumps for the delivery of fluids, i.e. gases and liquids as well as mixtures of the same, are known for a long time and are available in a great variety.

Also, the field of microsystem technology which is still young compared to other branches of industry needs according delivery means. Some of the pumping techniques which are known from the common art had been transferred in the past years into the field of microsystem technology with varying success. Here, a commonly underestimated problem consists in the provision of a bubble tolerant apparatus, since even smallest bubbles result in clogging of the channels and/or the pump chambers due to the small dimensions of the pump chambers which are used in micropumps.

Gas bubbles can form e.g. during the first use of the pump, due to bubbles that are already present in the pump medium, due to the generation of gas bubbles from a gas which is firstly dissolved in the liquid, or due to high under pressure.

From the state of the art, for example, pumps which are being based on silicon are known in which essential parts such as the pump membrane and/or valves are fabricated from silicon by means of etching techniques. Such a construction can, amongst others, be found in H. T. G. van Lintel, F. C M. van de Pol, “A piezoelectric micropump based on micromachining of Silicon”, Sensors and Actuators, 15 1988, p. 153-167. Commonly, such pumps are susceptible to gas bubbles in the fluid stream and are therefore often lined with hydrophilic coatings, wherein the high hydrophilicity of the basic material silicon is advantageous. However, the possibilities of avoiding problems related to gas bubbles which are dragged with the fluid stream are limited; in particular, in the case of single chamber pumps.

Usually, piezo-ceramic as well as thermal, electrostatic, or electromagnetic acting actuators are being used as drive.

Further, peristaltic pumps are described which have, due to their multi-chamber construction, the ability of pressing gas bubbles which are present in a first chamber into the next chamber by emptying the first chamber, without the risk of the gas bubble travelling back. Such a set up is e.g. described in document WO 95/20105. A pump cascade forms by lining-up several individual pumps. A continuous transport of the fluid in one direction is achieved by a phase shift which e.g. can be 120° in the case of three chambers.

Although, on one hand, such peristaltic pumps react robustly against gas bubbles in the fluid, they always need at least three chambers, since otherwise, the phase shift would be 180°, so that the delivery direction would not be defined anymore. Further, the drive of the three or more chambers needs an according amount of space and energy for operation.

### OBJECT OF THE INVENTION AND SOLUTION

Therefore, it is the object of the invention to provide an apparatus and a method for the delivery of fluids which is capable of miniaturization, energy efficient, and bubble tolerant, and which furthermore allows for an effective delivery.

Accordingly, an apparatus according to claim 1 and a method according to claim 13 is disclosed. Further embodiments are presented in the sub claims and can be taken from the following description as well as the accompanying drawings.

### DESCRIPTION

The invention relates in particular to an apparatus and a method for the bubble tolerant and effective delivery of a fluid, which is, due to its simple and robust construction, particularly suitable for the use in microsystem technology such as e.g. in the field of life sciences, medical technology, body hygiene, cosmetics, etc. Also, the aforementioned invention is well suitable for the use in environmental technology, in toys, or in other, exceptionally rough environments.

Accordingly, the invention comprises in particular the following basic components:
a number of at least two pump chambers having N separate chamber volumes, each of which may be altered independently of all others. Therein, the volume changes of the pump chambers occur periodically with substantially the same frequency f;
N actuators for changing the respective chamber volumes, wherein N corresponds to the number of the pump chamber, and wherein each actuator can be assigned to a specific pump chamber;
one or several valves for establishing the pumping direction;
a common inlet and a common outlet, each of which is designed independently of the other and preferably designed such that it can comprise elastic hoses, or, according to alternative embodiments, it can also be provided as screw thread, as luer fitting, as borehole, or as plug-in connection;
as well as, according to a preferred embodiment, a common housing, into which the described components can be integrated.

The invention is particularly characterized in that the N pump chambers are arranged in series one after the other, and that the shapes of the periods of volume changes of all pump chambers are substantially identical, and that an ideal phase shift PHI of approximately 180° exists between the volume change of the chamber volume of two subsequent pump chambers.

According to the type of the actuators, their control occurs for example electric, mechanical, magnetic, and preferably, the control curve of the actuator pre-sets the volume change in the respective pump chamber. An ideal phase shift must be differentiated from an actual phase shift PHI*; this means, that under certain conditions, as will be shown later on, an intentional deviation from the ideal value can be desired, but that firstly, however, a phase shift PHI of 180° from each pump chamber to the next must be adjusted in the basic configuration. Thus, in the case of four pump chambers, the first and the third one would operate in-phase, and the second and the fourth would operate just opposing to the first and third chamber.

According to a preferred embodiment of the apparatus according to the invention the same is characterized in that N=2, i.e. that it consists of just two pump chambers. This is the smallest of the possible numbers of chambers; as shown by experiments, the apparatus is capable to fulfil all requirements as they result from the aforementioned problem and in particular, the requirement of an excellent bubble tolerance, as long as the apparatus has the structure according to the invention as being disclosed herein, and as long as it is being used according to the method according to the invention which is yet to be described.

For a sufficient secure, i.e. in particular also bubble tolerant and efficient operation, the actual phase shift PHI* preferably should not differ more than ±7%, and particularly preferred, not more than ±3%, from the ideal phase shift PHI. Depending on the pump medium, density, temperature, flow velocity, and construction of the pump device, these numbers can vary; generally, a smaller deviation is always preferred. It is preferred that also the respective Nth and (N+2)th actuator can be controlled by respectively the same control curve, so that at least all even or all odd pump chambers respectively operate in exactly the same phase.

The apparatus according to the invention is designed for the use with fluids. Therein, the fluid is a liquid, a gas, or a liquid-gas-mixture in which the gas can be present dissolved in the liquid and/or in the form of bubbles. Such liquids can e.g. also be blood or other body liquids, in which dissolved gas is present that appears under certain pressure changes in the form of (usually undesired) gas bubbles which in turn can clog the pump device. By usage of the apparatus according to the invention such gas bubbles can not result anymore in a clogging of the pump device, which is of high importance in particular in the field of medical technology.

According to a preferred embodiment of the apparatus according to the invention, each pump chamber preferably comprises at least one own inlet and/or at least one own outlet valve, and particularly preferably two own inlet valves and two own outlet valves. Experiments have shown that by using double valves, an exceptionally high degree of reliability can be achieved in the operation of the apparatus.

According to a particularly preferred embodiment, the valves are arranged and designed in such a manner that the direction changes of the fluid stream being invoked by them are minimized. Thus, the energy which is necessary for the transport of the fluid is minimized, and the probability of settling of gas bubbles is further reduced. The precise design of the fluid components depends on the type of the actuators, pump chamber shapes, etc. being used; however, as a rule, changes of angle of the fluid path should not be abrupt, and in particular, right angles must be avoided. Changes from one fluid plane to another should occur suitably slow and flat, what means that the borehole that connects both fluid planes with each other has a diameter which is at least equal to its length.

According to a preferred embodiment of the apparatus according to the invention, the same is characterized in that it comprises piezo membrane actuators for the change of the respective chamber volumes. In particular, disk- or plate shaped actuators are particularly preferred. However, other actuators are possible as well for the change of the respective chamber volumes, such e.g. mechanical, thermal, magnetic, electrostatic, or other actuators, which result in a change of the chamber volume, wherein, in particular, such ones are particularly preferred which have an exceptionally low energy- and space consumption.

According to another preferred embodiment, all components which are in contact with the fluid consist of polyphenylene sulphone (PPSU). In particular with regard to the joining- and fabrication technique which is preferred for the joining of the invention, this material offers desirable advantages. Of course, however, the invention is in no means restricted to this material. For example it can be necessary in the medical field or in the field of environmental technology to specially coat the parts that are in contact with the fluid, e.g. by biocompatible or other particularly inert materials, in order to adapt the apparatus to the specific requirements. Also other materials such as silicon, metals, or glasses are possible, wherein it must be ensured in the case of materials having only a low stretchability it must be ensured that the actuators can still lead to a change of the chamber volume according to the invention.

According to another embodiment of the apparatus, all components that must be joined to each other can be joined using the technique of “penetration laser welding”. This technique is suitable in particular for the joining of plastics and offers, besides short production times, the possibility to produce a hermetically tight connection without adhesives that comes close to the strength of the source material. This technique is successfully being used in particular in the field of medical technology. Depending on the wavelength of the laser that is used for welding, care must be taken that accordingly, one absorbing and one transparent component must be joined to each other.

According to a further embodiment, the apparatus comprises geometrical features in such a manner that an incorrect mounting of the components is excluded to a large extent. This is particularly advantageous if the assembly of the apparatus takes place manually, and a risk of confusion exists as a result of possibly similar components of the individual pump chambers, or due to nearly symmetrical embodiments of these components. Such assembly faults must be avoided in any case since the correction of such assembly faults is time consuming and results in defective pumps in the worst case. According to the invention, this can be achieved in that certain marks or protrusions are located at the housing that allow the assembly of further components only in a very specific way so that assembly faults of practicality excluded, since these immediately stand out, or they are only possible under damage of the component. Therefore, such assembly aids preferably consist of one or several projecting parts, and of recesses corresponding with other components. Therein, such features are particularly preferred that run through the entire housing in a direction vertical to the individual layers or functional planes, so that only a minimal number of such features is necessary.

According to a particularly preferred embodiment, the apparatus is characterized in that the components which are necessary for the production of a single pump chamber, particularly the valve(s) and the actuator, are designed substantially interchangeable with, or identical as, the components which are necessary for the production of another pump chamber of the same apparatus. In other words, if possible, all according actuators, all valves, and optionally other components that are repeated in each pump chamber are respectively designed identical. In this way, on one hand, the risk of confusion during the assembly is reduced; on the other hand, costs of the production are minimized, since an accordingly higher number of identical components can normally be produced cheaper than several different variants with accordingly lower numbers of units.

According to a most preferred embodiment of the apparatus according to the invention, the same comprises the following components, wherein the list order essentially corresponds to the assembly sequence:
a base element with a recess as well as an inlet leading into the recess and an outlet leading out of the recess, as well as furthermore, with fluid structures which are arranged between the inlet and the outlet in the same plane for guidance of the fluid to be delivered to the valves, and to the fluidic connection of both pump chambers, and for the connection to the inlet and the outlet;
a valve foil which is insertable into the recess and which carries the moveable parts of the valves;
an intermediate layer which is insertable above the valve foil into the recess and which has openings which form the immobile parts of the valves;
a protection layer which is insertable above the intermediate layer into the recess, and which forms together with the intermediate layer two hollow spaces positioned in one plane which serve as pump chambers;
two actuators with electrodes and electric terminals, wherein each actuator is respectively arranged congruent with the pump chamber that is positioned below, and wherein the chamber volume of the pump chamber which is assigned to the actuator is changeable by operation of the actuator;
a lid element, the outer contours of which substantially correspond to the ones of the base element, and which is placeable on the base element and which closes the recess after connection with the base element in such a manner that the components which are present in its interior are protected from environmental influences.

Therein, the base element, the intermediate layer and the lid element can be connected fluid-tight with each other.

It is clear, that is listing can be supplemented by further components which are sensible or necessary for the according application, so that it must not be regarded as exhaustive.

According to another embodiment, the apparatus is not assembled as integrated variant as previously described, but by a sequential line-up of separate individual pumps. It thus consists of a serial arrangement of N separate individual pumps which respectively comprise only one pump chamber, and which are designed connectable with each other by means of fluidic ducts. Such ducts are preferably made from a most possible unyielding material in order to avoid the loss of energy due to (undesired) expansion of the ducts during each pump cycle. Therefore, such ducts are particularly preferred designed as short as possible, for example not more than 10 centimetres.

However, naturally, the control of the individual pumps occurs again according to the aforementioned pattern, according to which a phase shift PHI of respectively 180° exists between two subsequently arranged pump chambers.

According to a further preferred embodiment, the apparatus is designed such that information about the delivery status can be gained during ongoing operation. For this, the apparatus comprises the following characteristics:
At least one of the actuators is designed such that it can be switched off. For this, preferably, a circuit arrangement can be provided that allows not only the frequency controlled operation of the actuator, but that also provides a control possibility which allows a temporary or also continuous interruption of at least one or even several actuators during ongoing operation. Therein, the interrupt signal can “travel” e.g. from the first actuator in flow direction, so that always just one, but not always the same actuator temporarily stands still.
A circuit arrangement is provided which allows to detect an actuator's change of geometry which is generated by means of fluid pressure at this at least one switched off actuator during the operation of the apparatus by means of one or several not switched off actuators. In other words, the circuit arrangement allows a readout of the changes of geometry which are caused by the “passive”, i.e. drive energy-less, operation of the at least one switched off actuator. In the exemplary case of piezo-actuators, a voltage is induced by means of a change in geometry applied from the outside, e.g. by pressure change in the pump chamber, which then can be led via suitable electrical conduits to the outside where it can be measured. Particularly preferred, the same conduits can also be used as conduits which are already present for the operation of the respective actuator. Particularly preferred, the circuit which is provided for the read-out of the changes of geometry is integrated into the circuit for control and for the temporary switching off of the actuator(s), and, if desired, it is equipped with an interface to a control panel, a computer, or a radio transmitter.

Subsequently, in particular, the method according to invention is described in more detail which particularly preferred is executed together with the apparatus according to the invention.

Accordingly, the method is suitable for the bubble tolerant and efficient delivery of a fluid, wherein the method advantageously corresponds with an apparatus that:
consists of a number of N≧2 pump chambers with N separate chamber volumes, each of which may be altered independently of the other(s), wherein the volume changes of the pump chambers occur periodically with substantially the same frequency (f);
comprises N actuators for changing the respective chamber volumes;
furthermore provides one or several valves for establishing the pumping direction;
and finally comprises a common inlet and outlet.

Therein, the N pump chambers are arranged in series one after the other. The method according to the invention requires that the shapes of the periods of volume changes of all pump chambers are substantially identical, and that the pump chambers are driven in such a manner that an ideal phase shift PHI of approximately 180° exists between the volume change of the chamber volume of two subsequent pump chambers.

According to a preferred embodiment, the method according to the invention corresponds to an apparatus for which N=2, which thus consists of two pump chambers. According to the method according to the invention, the phase shift between the first and the second pump chamber is 180°.

According to a preferred embodiment, an actual phase shift PHI* preferably differs not more that ±7%, and particularly preferably not more than ±3% from the ideal phase shift PHI. Generally, the rule is valid that smaller deviations from the ideal value are always to be preferred.

Particularly preferred, the method according to the invention is suitable for the delivery of fluids which are selected from the group of liquids, gases, as well as liquid-gas-mixtures, wherein in the case of a mixture, the method is suitable for gas contents which are present being dissolved in the liquid as well as in the form of bubbles.

Preferably, the change of the volume of each pump chamber takes place according to a square wave. In the case of electrically driven actuators such as e.g. piezo-actuators, this means that in the ideal case, their control occurs by means of rectangular voltages that are phase shifted to each other. Due to the control by means of rectangular voltages, the actuator moves accordingly, which in the optimal case results in a nearly rectangular running cyclic volume change of the respective pump chamber. In the case that the relation between control of the actuator and volume change of the pump chamber is not proportional, according correction factors or -functions can be used.

According to a preferred embodiment of the method according to the invention, the rising and/or the falling edge of the square wave voltage/curve is rounded in such a manner that cavitation effects in the pump chamber that result from a too low chamber pressure are avoided. Experiments have shown that a low pressure can build up in the pump chamber because of a too fast relaxation of the actuator, leading to spontaneous gas bubble formation, since the boiling-point in a fluid depends on its pressure state and accordingly decreases in the case of lower pressures; in extreme cases, up to room temperature. Due to the subsequent collapsing off the cavitation gas bubbles during normalization of the pressure, strong pressure waves develop which, when occurring continuously, can result in significant material damage, and thus must be avoided.

According to a further embodiment of the method according to the invention, the frequencies f of the volume changes of subsequent pump chambers temporarily or continuously provide a difference Δ. This difference must be regarded as a desired, intentionally adjusted difference in the frequency of the individual chambers. If, for example, the difference amounts at an operation frequency of 100 Hz to just 1 Hz, the differing chamber reaches after 100 cycles the phase shift which is the same as at the beginning of the induced frequency change. As could be demonstrated by experiments, this temporary induction of a so-called “beating” is particularly suitable for expelling of gas bubbles which otherwise can not be loosened from the fluidic channels of the apparatus. In order to receive an optimal result, depending on the concrete design of the apparatus as well the physical characteristics of the fluid, the difference Δ can be of variable magnitude and of variable length.

According to a particularly preferred embodiment of the method, the difference Δ is preferably smaller than 1% of the frequency f, and particularly preferably smaller than 0.1% of the frequency f.

According to a preferred embodiment of the method according to the invention, the same can be used for gaining information about the delivery status during ongoing operation. For this, at least one of the following steps must be carried out; preferably, all of the following steps must be carried out one after another:

(1) Temporary or continuous switching off of one or several actuators. This is in particular sensible if either the actuator itself offers the possibility to serve as a sensor for pressure changes in the respective pump chamber, or if a suitable pressure sensor is present otherwise.

(2) Detecting of the changes of shapes which are generated at the actuator(s) due to fluid pressure. Particularly preferred, this is possible by means of piezo-actuators which generate in the “passive” operation, i.e. without applying an electric voltage, a voltage itself as soon as they are subjected to a change of geometry. Under certain conditions, the pressure, the change of geometry caused by it, and the thus produced voltage are proportional to each other as well, so that a piezo-actuator is convertible into a simple pressure sensor.

(3) Comparison of the detected changes of shapes with nominal values resulting from proper operation. If values, e.g. voltage values, from an operation without fault are known, the presence of a fault can be deduced by a simple, qualitative comparison, or, by qualitative comparison, the magnitude of the fault can be deduced in a first approximation as well.

According to the embodiment, the fault detection can be taken over by one or several actuators only temporarily, or one or several actuators can be lastingly converted into fault sensors. Also, the read-out of one or several separately introduced and here not specified sensors can temporarily serve for the detection of faults. However, that very embodiment is advantageous according to which the anyway present actuators are temporarily being used as fault sensors.

According to a particularly preferred embodiment of the method according to the invention, in case of detection of a malfunction, for the extermination of the same, a change of the operation as described above is temporarily initiated, i.e. a beating according to the invention is generated by which a malfunction can be fixed again, as long as it was caused by the presence of a gas bubble that could not otherwise be removed.

### OVERVIEW TO THE FIGURES

FIG. 1: Exploded view of the apparatus according to the invention

FIG. 2: Optimized curve progression for control or volume change

FIG. 3: Curve progression for phases being shifted of 180′; duty factor=1:1

FIG. 4: Curve progression for phases being shifted of 180°; duty factor≠1:1

### DESCRIPTION OF FIGURES

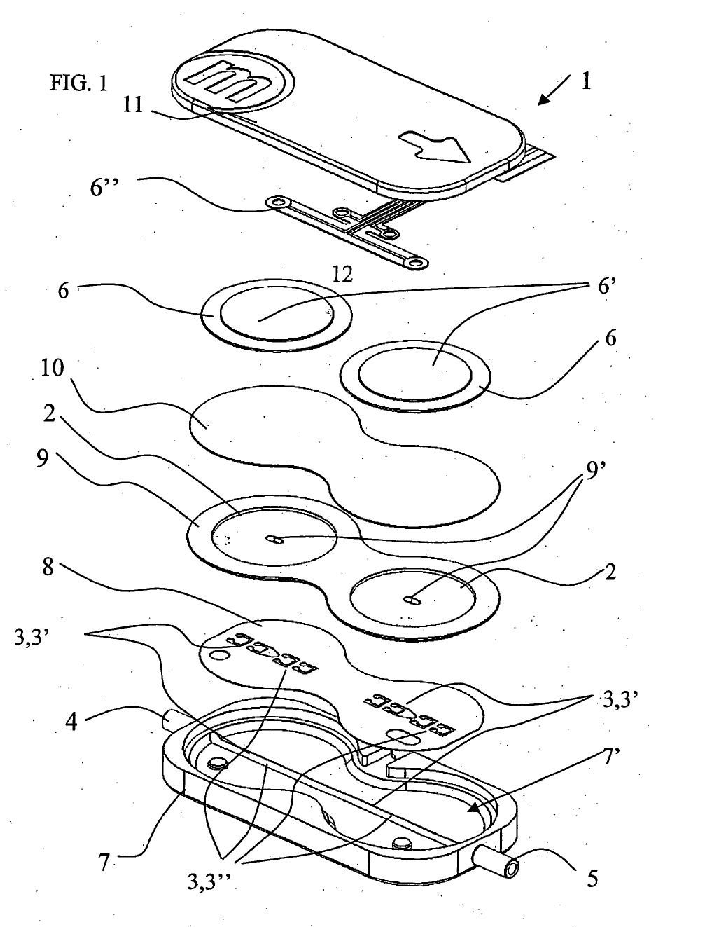

FIG. 1 shows and exploded view of a particularly preferred embodiment of the apparatus 1 according to the invention. The same consist of a layered assembly 1, which comprises two pump chambers 2 in the depicted case.

According to FIG. 1, the assembly 1 consists in detail of the following components:
a base element 7, which particularly preferred is being made of plastics. The base element comprises a recess 7′ into which all subsequent components are inserted or put onto. The base element also preferably includes inlet 4 and exit 5 which are necessary for the delivery of the fluid, and which, as depicted here, are e.g. respectively designed as a hose-like connector. Naturally, other connector types which are adapted to the respective application are possible as well. The base element also comprises parts of the fluid channels which are necessary for the valves 3 which are preferably produced by injection moulding, and therefore, in the same process as the base element itself.

Furthermore, the base element carries projecting parts of the same 7″ as mounting aids in the form of geometric features, which are arranged in such a manner that they cooperate with the recesses of the mounting aid 7′″. Therefore, the assembly of subsequent components such as e.g. the valve foil 8 can only occur in one certain way, so that an incorrect mounting is excluded to a large extent.
a valve foil 8, which carries the movable parts of the valves 3 and which is being inserted into the base element. In the depicted embodiment, the valve foil comprises the movable parts of the inlet valves 3′ of each pump chamber, as well as the movable parts of the respective outlet valves 3″. Furthermore, the valve foil also comprises the recesses of the mounting aid 7′″ which serve for a faultless insertion of the valve foil.
an intermediate layer 9, which is preferably made of plastics. It is designed in such a manner that it can be inserted into the recess 7′ of the base element 7. In the centre of each pump chamber 2 which is respectively formed by a recess in the intermediate layer, one respective opening 9′ is located through which fluid can respectively flow into the pump chamber or out of the same.
a protection layer 10, which is applied onto the intermediate layer and thus fluidically borders the pump chamber to the above. Thus, the protection layer must be firmly connected with the intermediate layer, so that fluid can exit or flow over neither at its circumference nor in the region between the pump chambers. As already mentioned, preferably, penetration laser welding is being used therefore. Alternative production techniques are gluing, ultrasound welding, or mechanical clamping of the respective components.
two actuators 6, which are provided as disc shaped piezo-actuators in the depicted embodiment. Each of the actuators is geometrically adapted to the pump chamber 2 which is arranged below, and it carries according electrodes 6′ for the electrical contacting. Connected to these is an electric terminal 6″ which can be led out of the housing of the apparatus 1, and which provides a sufficient number of individual wires for the connection of each actuator.
a lid element 11, which serves as a seal of the apparatus' 1 housing which substantially consists of the base element 7. Preferably, the lid element is also fabricated from plastic and is designed such that it can be connected with the base element by means of penetration laser welding.

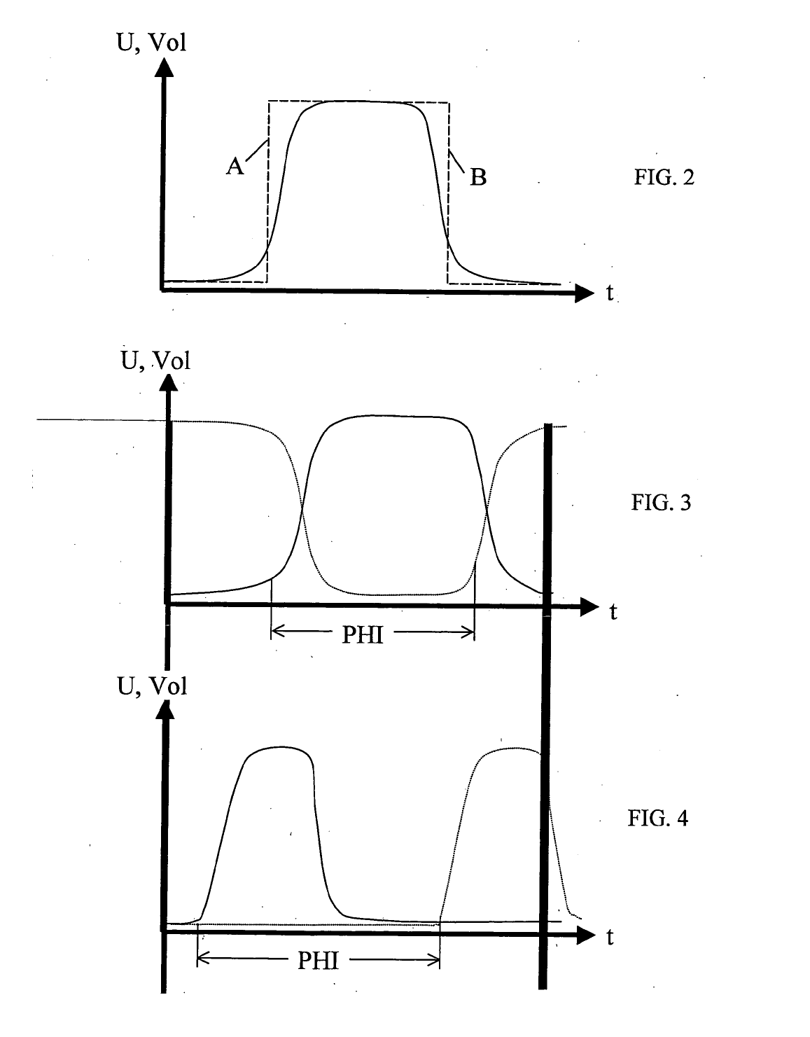

FIG. 2 shows a diagram in which the time is plotted on the abscissa, and the actuator voltage U (called “control curve” in the following) and/or the volume of a pump chamber (called “chamber volume curve” in the following) is/are plotted on the ordinate. The depicted timeframe corresponds to just one period, i.e. the time that is necessary for one single pump cycle of a pump chamber.

Here, the dashed line shows an ideal rectangular curve. According to the invention, the rising edge A as well as the falling edge B of this curve can be rounded, so that a progression results according to the solid line which indicates the optimized curve progression. As described above, this rounding serves for the avoidance of pressure change peaks, which could lead to undesired formation of cavitation bubbles. The precise optimized shapes of the roundings must be determined according to the exact geometrical design of the pump chambers, the fluid channels, and the magnitude of the operating pressures. This can e.g. occur by calculation, simulation, and/or the execution of test series. Therefore, the depicted shape is only to be regarded as a symbol and must not correspond to the actual, optimal shape of the control- or the chamber volume curve.

FIG. 3 shows a diagram with identical axis labelling as previously FIG. 2. Also, it shows the solid line from FIG. 2, which reflects the optimized curve progression of the control- or the chamber volume curve. Additionally, a curve which is phase shifted of PHI=180° is drawn as a dotted line which shows the control curve of the actuator that follows the one that is controlled according to the solid line. In the present depicted variant, the lifting- and lowering phases of an actuator, the so-called duty cycle, is approximately of the same length, which is where the nearly mirrored shape of the dotted line results from (duty cycle 1:1). In cases in which the duty cycle is not of identical magnitude, pictures result in which the trail of the second control curve accordingly does not result as a mirroring of the first.

This case is depicted in FIG. 4. Here, the phase response PHI is again 180°, the duty cycle, however, is approx. 1:3 (the period in which the curve shows a higher value is significantly shorter than the part in which it is close to zero).

Method for supplying a fluid and micropump for said purpose

### LIST OF REFERENCES

1 method for delivery of a fluid
2 pumping chamber
3 valve
3′ inlet valve
3″ outlet valve
4 inlet
5 outlet
6 actuator, piezo membrane actuator
6′ electrode
6″ electric terminal
7 base element
7′ recess
7″ projecting part of the mounting aid
7′″ recesses of the mounting aid
8 valve foil
9 intermediate layer
9′ openings
10 protection layer
11 lid element
A rising edge
B falling edge

1. Apparatus for the bubble tolerant delivery of a fluid, comprising
a number of N≧2 pump chambers having N separate chamber volumes, each of which may be altered independently of the other(s), wherein the volume changes of the pump chambers (2) occur periodically with substantially the same frequency (f);
N actuators for changing the respective chamber volumes;
valves (3) for establishing the pumping direction;
a common inlet (4) and outlet (5); characterized in that the N pump chambers (2) are arranged in series one after the other, and the shapes of the periods of volume changes of all pump chambers (2) are substantially identical, and that an ideal phase shift PHI of approximately 180° exists between the volume change of the chamber volume of two subsequent pump chambers (2).

2. Apparatus according to claim 1, characterized in that N=2.

3. Apparatus according to claim 1, characterized in that an actual phase shift PHI* preferably differs not more that ±7%, and particularly preferably not more than ±3% from the ideal phase shift PHI.

4. Apparatus according to claim 1, characterized in that the fluid is a liquid, a gas, or a liquid-gas-mixture in which the gas can be present dissolved in the liquid and/or in the form of bubbles.

5. Apparatus according to claim 1, characterized in that each pump chamber (2) preferably comprises at least one own inlet and/or at least one own outlet valve, and particularly preferably comprises two own inlet valves (3′) and two own outlet valves (3″), and that the valves are arranged and designed in such a manner that the direction changes of the fluid stream being invoked by them are minimized.

6. Apparatus according to claim 1, characterized in that it comprises piezo membrane actuators (6) for the change of the respective chamber volumes.

7. Apparatus according to claim 1, characterized in that all components which are in contact with the fluid consist of polyphenylene sulphone (PPSU).

8. Apparatus according to claim 1, characterized in that all components that must be joined to each other can be joined using penetration laser welding.

9. Apparatus according to claim 1, characterized in that the components are designed such that an incorrect mounting is excluded to a large extent.

10. Apparatus according to claim 1, characterized in that the components which are necessary for the production of a single pump chamber (2), particularly the valve(s) (3) and the actuator (6), are designed substantially interchangeable with, or identical as, the components which are necessary for the production of another pump chamber (2) of the same apparatus.

11. Apparatus according to claim 1, characterized in that it comprises the following components:
a base element (7) with a recess (7′) as well as an inlet (4) leading into the recess (7′) and an outlet (5) leading out of the recess (7′), as well as furthermore, with fluid structures which are arranged between the inlet and the outlet in the same plane for guidance of the fluid to be delivered to the valves (3, 3′, 3″), and to the fluidic connection of both pump chambers (2), and for the connection to the inlet (4) and the outlet (5);
a valve foil (8) which is insertable into the recess (7′) and which carries the moveable parts of the valves (3, 3′, 3″);
an intermediate layer (9) which is insertable above the valve foil (8) into the recess (7′) and which has openings (9′) which form the immobile parts of the valves (3, 3′, 3″);
a protection layer (10) which is insertable above the intermediate layer (9) into the recess (7′), and which forms together with the intermediate layer (9) two hollow spaces positioned in one plane which serve as pump chambers (2);
two actuators (6) with electrodes (6′) and electric terminals (6″), wherein each actuator (6) is respectively arranged congruent with the pump chamber (2) that is positioned below, and wherein the chamber volume of the pump chamber (2) which is respectively positioned below the actuator (6) is changeable by operation of the actuator (6);
a lid element (11), the outer contours of which substantially correspond to the ones of the base element (7), and which is placeable on the base element (7) and which closes the recess (7′) after connection with the base element (7) in such a manner that the components which are present in its interior are protected from environmental influences
and in which base element (7), intermediate layer (9) and lid element (11) can be connected fluid-tight with each other.

12. Apparatus according to claim 1, characterized in that the same is formed by a serial arrangement of N separate individual pumps which respectively comprise only one pump chamber (2), and which are designed connectable with each other by means of fluidic ducts.

13. Apparatus according to any claim 1, wherein: the apparatus is designed such that information about the delivery status can be gained during ongoing operation in such a manner, wherein for this, the apparatus comprises the following characteristics:
at least one of the actuators (6) is designed such that it can be switched off;
a circuit arrangement is provided which allows to detect the changes of shape of a actuator (6) which are generated due to fluid pressure at the switched off actuator (6) during operation of the apparatus by means of a not switched off actuator (7).

14. Method for the bubble tolerant delivery of a fluid, with:
a number of N≧2 pump chambers (2) with N separate chamber volumes, each of which may be altered independently of the other(s), wherein the volume changes of the pump chambers (2) occur periodically with substantially the same frequency (f);
N actuators (6) for changing the respective chamber volumes;
valves (3) for establishing the pumping direction;
a common inlet (4) and outlet (5); wherein the N pump chambers (2) are arranged in series one after the other, and the shapes of the periods of volume changes of all pump chambers (2) are substantially identical, and that the pump chambers (2) are driven in such a manner that an ideal phase shift PHI of approximately 180° exists between the volume change of the chamber volume of two subsequent pump chambers (2).

15. Method according to claim 14, characterized in that N=2.

16. Method according to claim 14, characterized in that an actual phase shift PHI* preferably differs not more that ±7%, and particularly preferably not more than ±3% from the ideal phase shift PHI.

17. Method for the delivery of fluids according to claim 14, characterized in that, for the execution of the method, an apparatus according to any of the preceding claims 1 to 12 is being used.

18. Method according to claim 14, characterized in that the control of the actuators (6) substantially takes place by means of phase shifted square wave voltages.

19. Method according to claim 18, characterized in that the rising and/or the falling edge of the square wave voltage/curve is rounded in such a manner that cavitation effects in the pump chamber (2) that result from a too low chamber pressure are avoided.

20. Method according to claim 14, characterized in that the frequencies f of the volume changes of subsequent pump chambers (2) temporarily or continuously provide a difference Δ.

21. Method according to claim 20, characterized in that the difference Δ is preferably smaller than 1% of the frequency f, and particularly preferably smaller than 0.1% of the frequency f.

22. Method according to claim 14, characterized in that information about the delivery status are gained during ongoing operation in such a manner that at least one of the following steps, and preferably, all steps are subsequently executed:
temporary or continuous switching off of one or several actuators (6);
detecting of the changes of shapes which are generated at the actuator(s) (6) due to fluid pressure;
comparison of the detected changes of shapes with nominal values resulting from proper operation.

23. Method according to claim 22, characterized in that, in case of detection of a malfunction, for the extermination of the same, a change of the operation according to claim 20 is temporarily initiated.
